(19) United States
(12) Patent Application Publication
(10) Pub. No.: US 2020/0210714 A1
(43) Pub. Date: Jul. 2, 2020

(54) DETERMINATION DEVICE AND COMPUTER PROGRAM PRODUCT

(71) Applicant: FUJITSU CLIENT COMPUTING LIMITED, Kanagawa (JP)

(72) Inventor: Kei Kato, Kawasaki (JP)

(73) Assignee: FUJITSU CLIENT COMPUTING LIMITED, Kanagawa (JP)

(21) Appl. No.: 16/685,403

(22) Filed: Nov. 15, 2019

(30) Foreign Application Priority Data
Dec. 28, 2018 (JP) 2018-247563

(51) Int. Cl. G06K 9/00

(52) U.S. Cl. CPC G06K 9/00771; G06K 9/00369; G06K 9/00355; G06K 9/00348

(57) ABSTRACT

A determination device includes: an acquirer, a determiner, and an output. The acquirer acquires first data and second data from image data of a person. The first data represents a physical characteristic of the person and the second data represents an accessory of the person. The determiner derives first information from the first data and the second data, and determines the person based on the first information. The output outputs a result of the determined person.

### CROSS-REFERENCE TO RELATED APPLICATIONS

This application is based upon and claims the benefit of priority from Japanese Patent Application No. 2018-247563, filed Dec. 28, 2018, the entire contents of which are incorporated herein by reference.

### TECHNICAL FIELD

Embodiments described herein relate generally to a determination device and a computer program product.

### BACKGROUND

Conventionally, for example, devices that determine whether a person is suspicious from his or her behavior are known.

It is useful for such a device to determine a person from a new perspective, for example.

It is thus preferable to provide a determination device and a computer program product that can determine a person from a new perspective.

### SUMMARY

According to one embodiment, in general, a determination device includes an acquirer that acquires first data and second data from image data of a person, the first data representing a physical characteristic of the person, the second data representing an accessory of the person; a determiner that derives first information from the first data and the second data acquired by the acquirer, and determines the person on the basis of the first information; and an output that outputs a result of the person determination by the determiner.

### BRIEF DESCRIPTION OF THE DRAWINGS

FIG. 1 is a block diagram illustrating an exemplary configuration of a suspicious-person determining system according to an embodiment;

FIG. 2 is a block diagram illustrating an exemplary configuration of a determination device according to the embodiment;

FIG. 3 is a block diagram of an exemplary functional configuration of the determination device according to the embodiment;

FIG. 4 illustrates an exemplary object detection to be executed by an object detector of the determination device according to the embodiment;

FIG. 5 illustrates an exemplary skeleton estimation to be executed by a skeleton estimator of the determination device according to the embodiment;

FIG. 6 illustrates an exemplary extraction to be executed by a data extractor of the determination device according to the embodiment;

FIG. 7 illustrates an exemplary behavior suspiciousness determination to be executed by a behavior-suspiciousness determiner of the determination device according to the embodiment;

FIG. 8 illustrates another exemplary behavior suspiciousness determination to be executed by the behavior-suspiciousness determiner of the determination device according to the embodiment;

FIG. 9 is a table illustrating scores at certain time that are obtained through the determination executed by the determination device according to the embodiment; and

FIG. 10 is a chart illustrating scores in time series obtained through the determination executed by the determination device according to the embodiment.

### DETAILED DESCRIPTION

The following will disclose an exemplary embodiment. Configurations of the following embodiment and operations and effects attained by the configurations are merely exemplary. The embodiment can be carried out by configurations other than those disclosed herein. The embodiment can attain at least one of various effects including derivative effects attained by the configurations.

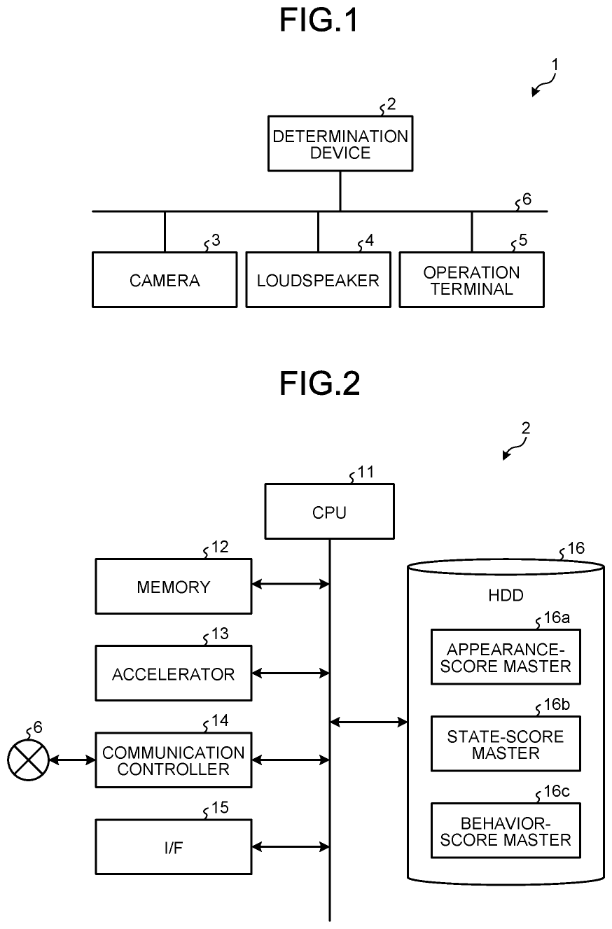

FIG. 1 is a block diagram illustrating an exemplary configuration of a suspicious-person determining system 1 according to the embodiment. The suspicious-person determining system 1 illustrated in FIG. 1 generates image data of a person who has entered a retailer premise, to determine whether the person is suspicious from the generated image data, for example. Hereinafter, a person being a subject of the suspicious-person determination may be referred to as a target person.

The suspicious-person determining system 1 includes a determination device 2, a camera 3, a loudspeaker 4, and an operation terminal 5. The determination device 2 and the operation terminal 5 are installed in the backyard of a shop, and the camera 3 and the loudspeaker 4 in a selling space thereof, for example. The determination device 2, the camera 3, the loudspeaker 4, and the operation terminal 5 are communicably connected to one another via a communication network 6 such as a local area network (LAN).

The camera 3 serves as an area camera or an area sensor that can generate two-dimensional color image data. The camera 3 generates images of the selling space of the shop and transmits generated image data to the determination device 2 via the communication network 6. The number of cameras 3 installed in the selling space may be one or two or more. The camera 3 is also referred to as an imaging device.

The loudspeaker 4 can output sound (sound wave) having a directivity to the selling space of the shop, for example. The loudspeaker 4 outputs sound under the control of the determination device 2 or the operation terminal 5. The number of loudspeakers 4 installed in the selling space may be one or two or more. The loudspeaker 4 is also referred to as an output device.

The operation terminal 5 includes a central processing unit (CPU), a memory, an operation device, and a display device. The memory includes a read-only memory (ROM) and a random access memory (RAM). That is, the operation terminal 5 has the same hardware configuration as a general computer. The operation device includes a keyboard and a mouse. The display device is, for example, a liquid crystal display device. The operation terminal 5 is also referred to as an information processing device.

FIG. 2 is a block diagram illustrating an exemplary configuration of the determination device 2 according to the embodiment. As illustrated in FIG. 2, the determination device 2 includes a CPU 11, a memory 12, an accelerator 13, a communication controller 14, and an interface (I/F in FIG. 2) 15, and an HDD 16. The memory 12 includes a ROM and a RAM. The determination device 2 is an exemplary computer. The determination device 2 is also referred to as a suspicious-person detector.

The CPU 11 reads and executes a computer program or application from the ROM of the memory 12 or the HDD 16. The CPU 11 is configured to be able to perform various computations in parallel. The RAM of the memory 12 temporarily stores various kinds of data for use in the CPU 11's executing computer programs for various computations.

The accelerator 13 includes a graphics processing unit (GPU) and executes various kinds of image data processing.

The communication controller 14 is an interface for enabling the CPU 11 to perform data communication with other devices via the communication network 6. The interface 15 is, for example, universal serial bus (USB) compliant and enables the CPU 11 to perform data communication with other devices without the communication network 6. In the present embodiment, the operation terminal 5, the camera 3, and the loudspeaker 4 are connected to the CPU 11 via the communication controller 14, however, is not limited to such a connection. For example, the operation terminal 5, the camera 3, and the loudspeaker 4 may be connected to the CPU 11 via the communication interface 15.

The HDD 16 stores an operating system (OS), computer programs, and various files. The various files stored in the HDD 16 contain an appearance-score master 16a, a state-score master 16b, and a behavior-score master 16c. The appearance-score master 16a, the state-score master 16b, and the behavior-score master 16c will be described in detail later.

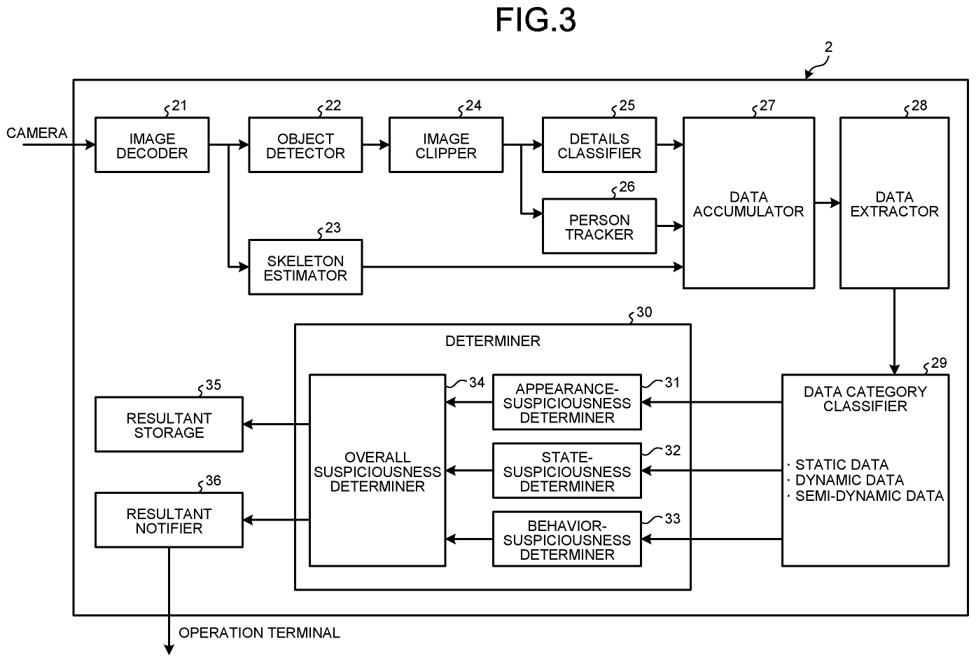

FIG. 3 is a block diagram of an exemplary functional configuration of the determination device 2 according to the embodiment. As illustrated in FIG. 3, the determination device 2 includes an image decoder 21, an object detector 22, a skeleton estimator 23, an image clipper 24, a details classifier 25, a person tracker 26, a data accumulator 27, a data extractor 28, a data category classifier 29, a determiner 30, a resultant storage 35, and a resultant notifier 36 as functional elements. These functional elements are implemented by executing computer programs stored in the HDD 16 by the CPU 11 and the GPU of the accelerator 13. As an example, the object detector 22, the skeleton estimator 23, the image clipper 24, the details classifier 25, and the person tracker 26 are implemented by the GPU of the accelerator 13, while the image decoder 21, the data accumulator 27, the data extractor 28, the data category classifier 29, the determiner 30, the resultant storage 35, and the resultant notifier 36 are implemented by the CPU 11. The assignation of the respective elements is not limited to the above example. Part or all of the functional elements may be implemented by dedicated hardware or circuitry.

The image decoder 21 decodes image data from the camera 3.

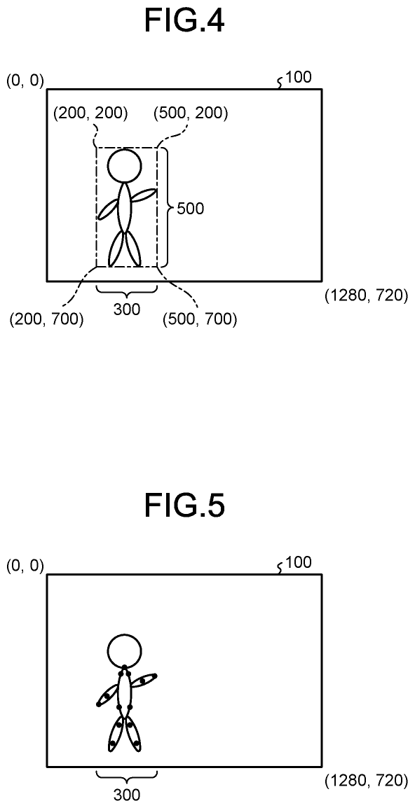

The object detector 22 detects intended objects (hereinafter simply referred to as objects) from the decoded image data by a known method. The objects include a target person and accessories of the target person, for example. The object detector 22 detects the entire object and parts of the object. For example, the object detector 22 detects the entirety of the target person and parts of the target person such as hands, face, and head. FIG. 4 illustrates an exemplary object detection process to be executed by the object detector 22 of the determination device 2 according to the embodiment. As illustrated in FIG. 4, the object detector 22 detects coordinates of a region surrounding an object (e.g., a target person in FIG. 4) from each frame of image data 100. For example, the origin (0, 0) is set to the coordinates of the upper left corner of an image (in height of 720 and width of 1280). In the example of FIG. 4, the object detector 22 detects the coordinates (200, 200) of the upper left corner, the coordinates (200, 700) of the lower left corner, the coordinates (500, 200) of the upper right corner, and the coordinates (500, 700) of the lower right corner of the region (in height of 500 and width of 300) surrounding the target person, to specify the region. While FIG. 4 depicts an example of the coordinates of a rectangular region surrounding the entire object, the object detector 22 also detects the coordinates of respective regions surrounding the parts of the object. The object detector 22 calculates the reliability of the detected coordinates of the object by a known method. The object detector 22 estimates or calculates the size of the object from the detected coordinates. The accessories of the target person can also be referred to as objects moving together with the target person.

Referring back to FIG. 3, the image clipper 24 clips, from the image data, the respective regions for the objects detected by the object detector 22. Hereinafter, each of the regions clipped by the image clipper 24 is also referred to as clipped image data.

The details classifier 25 breaks down or specifies the features of clipped image data by a known method. Examples of the breakdown of the target person by the details classifier 25 include outfit, age, gender, and orientations of face and body. Examples of the breakdown of hands by the details classifier 25 include state of gripping and opening. Examples of the breakdown of the face by the details classifier 25 include facial orientation, age, gender, expression, wearing glasses or no glasses, and visual line. Examples of the breakdown of the head by the details classifier 25 include head orientation, presence or absence of headwear, hairstyle, and hair color. Examples of the breakdown of a container by the details classifier 25 include a bag, a backpack, a handbag, a suitcase with wheels, and another container. Examples of the breakdown of a bag by the details classifier 25 include a paper bag and a plastic bag.

The details classifier 25 sets data representing the target parson by associating the categorized items of data as above with one another. Target-person data contains, for example, at least one of the features such as age, gender, face orientation, presence or absence of accessory, and the state of accessory if found. The details classifier 25 transmits, to the data accumulator 27, the target-person data as a result of the breaking down.

By a known tracking method, for example, the person tracker 26 tracks the target person detected by the object detector 22. This enables extraction of data for each target person. The person tracker 26 transmits track data representing a result of the tracking, to the data accumulator 27.

The skeleton estimator 23 estimates or calculates the skeleton of the target person detected by the object detector 22. Specifically, the skeleton estimator 23 estimates or calculates coordinates of respective points of, for example, a neck, a right shoulder, and a right elbow. The skeleton estimator 23 transmits skeleton data representing an estimation of the skeleton, to the data accumulator 27.

The data accumulator 27 stores the target-person data from the details classifier 25, the track data from the person tracker 26, and the skeleton data from the skeleton estimator 23 in a storage such as the memory 12 or the HDD 16. That is, the data accumulator 27 accumulates the target-person data, the track data, and the skeleton data in the storage.

The series of processing by the object detector 22, the image clipper 24, the details classifier 25, and the person tracker 26, and the processing by the skeleton estimator 23 are implemented by inputting image data to a trained model (parameters) generated through machine learning, for example.

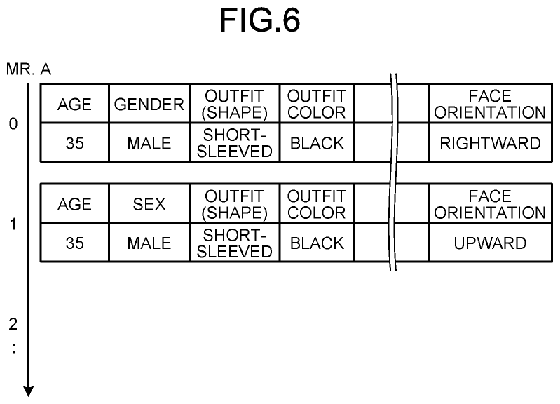

FIG. 6 illustrates an exemplary extraction process to be executed by the data extractor 28 of the determination device 2 according to the embodiment. As illustrated in FIG. 6, the data extractor 28 extracts various kinds of data such as the target-person data, the track data, and the skeleton data accumulated by the data accumulator 27 for each target person, and arranges the extracted data in time series. That is, the data extractor 28 arranges the target-person data, the track data, and the skeleton data for each target person in order of frames of the generated image data 100. The extracted data thus arranged in time series is also referred to as chronological data.

The data category classifier 29 breaks down items of data, contained in the chronological data acquired by the data extractor 28, into static data, semi-dynamic data, and dynamic data. That is, the data category classifier 29 acquires the static data, the semi-dynamic data, and the dynamic data from the chronological data acquired by the data extractor 28. The data category classifier 29 is an exemplary acquirer. The static data is exemplary first data. The semi-dynamic data is exemplary second data. The dynamic data is exemplary third data.

The static data represents a physical characteristic or characteristics of each target person. Specifically, the static data include age, gender, and height. It can be said that the static data represents features that do not change or may change over time. The static data can be detected from one or two or more frames of the image data. The present embodiment presents an example of setting candidate data (such as age, gender, or height) for the static data and determining candidate data as the static data if the candidate data presents no change over two or more (for example, 10) frames, that is, the candidate data remains the same.

The semi-dynamic data represents an accessory or accessories of each target person. Specifically, examples of accessories represented by the semi-dynamic data include outfit, belongings, and vehicle. The outfit includes types, shapes or forms, and colors of outfits. Examples of the types of outfit include a shirt (such as a long-sleeved shirt or a short-sleeved shirt), pants (such as long pants or short pants), a skirt, outerwear (such as a jacket or a coat), a headwear (such as a cap, a hat, or a helmet), a school uniform, glasses, and a mask. Examples of the belongings include a first container (such as a bag, a backpack, a handbag, a suitcase with wheels, or a grocery bag) that can contain an object, a second container bag (such as a grocery bag such as a paper bag or a plastic bag) that can contain an object, an umbrella, a purse, a cellular phone, and a cart. Examples of the vehicle include a baby stroller and a wheelchair. The semi-dynamic data can be detected from one or two or more frames of the image data. The present embodiment presents an example of determining, as the semi-dynamic data, an item of candidate data appearing most in two or more (for example, 50) frames, among items of candidate data for the static data.

The dynamic data represents the motion or motions of each target person. Specifically, the dynamic data include face orientations, hand positions, and body orientations of the target person over two or more frames. That is, the dynamic data indicates change or no change over time in face orientation, hand positions, and body orientation of the target person. The dynamic data can be referred to as data for specifying the motion of each target person.

The determiner 30 determines whether each target person is suspicious on the basis of the static data, the semi-dynamic data, and the dynamic data acquired by the data category classifier 29. Specifically, from the static data, the semi-dynamic data, and the dynamic data, the determiner 30 calculates a score indicating the degree of suspiciousness about the target person, to determine whether the target person is a suspicious person according to the scores. The degree of suspiciousness is an indicator of suspiciousness. The higher the score is, the more suspicious the person concerned is. Next, the determiner 30 is described in detail.

The determiner 30 includes an appearance-suspiciousness determiner 31, a state-suspiciousness determiner 32, a behavior-suspiciousness determiner 33, and an overall suspiciousness determiner 34.

The appearance-suspiciousness determiner 31 determines how suspicious the target person appears. Specifically, the appearance-suspiciousness determiner 31 derives or calculates an appearance score, which represents the degree of suspiciousness about the appearance of the target person, from the static data and the semi-dynamic data of the target person acquired by the data category classifier 29 and the appearance-score master 16a stored in the HDD 16. The appearance score is exemplary first information.

The appearance is determined by the physical characteristics of the target person indicated by the static data; and states of the target person and of accessories of the target person indicated by the semi-dynamic data. That is, the appearance is, for example, based on the static data and the semi-dynamic data. The appearance-score master 16a stores therein scores individually associated with physical characteristics represented by the static data of each target person and states of the target person and of accessories of the target person represented by the semi-dynamic data. The appearance-score master 16a also stores therein scores individually associated with combinations of the physical characteristics represented by the static data of each target person and states of the target person and accessories of the target person represented by the semi-dynamic data. Examples of the combinations include a combination of a young person (younger age group) and his or her physical characteristics and a combination of an aged person (elderly age group) and his or her physical characteristics. For example, the combination of a young person (younger age group) and his or her physical characteristics is assigned with a higher or lower score than the combination of an elderly person (elderly age group) and his or her physical characteristics.

The appearance-suspiciousness determiner 31 acquires, from the appearance-score master 16a, scores of the physical characteristics of each target person represented by the static data, scores of the states of the target person and of accessories of the target person, and scores of the combinations of the physical characteristics of the target person and the states of the target person and of accessories of the target person represented by the semi-dynamic data. The appearance-suspiciousness determiner 31 sets the sum of the one or more acquired scores as the appearance score.

The state-suspiciousness determiner 32 determines the degree of suspiciousness about the states of each target person and of accessories of the target person. Specifically, the state-suspiciousness determiner 32 derives or calculates a state score indicating the degree of suspiciousness about the states of the target person, from the semi-dynamic data and the dynamic data of the target person acquired by the data category classifier 29 and the state-score master 16b stored in the HDD 16. The state score is exemplary second information.

The states of each target person and of accessories of the target person are determined by states represented by the semi-dynamic data of the target person and of accessories of the target person. That is, the state of the target person bases on the semi-dynamic data and the dynamic data, for example. The state-score master 16b stores therein the scores of the states of each target person and accessories of the target person. Specifically, the state-score master 16b stores therein scores associated with the semi-dynamic data and the dynamic data. The state-suspiciousness determiner 32 acquires, from the state-score master 16b, scores of the states of the target person and of accessories of the target person. The state-suspiciousness determiner 32 sets the sum of one or more acquired scores as the state score.

In the case of an outfit being the accessory, examples of the states of each target person and of an accessory of the target person include a state of the target person wearing an outer wear or wearing no outer wear. In the case of a mask being the accessory, examples of the states of each target person and of an accessory of the target person includes the state of the target person wearing a mask or wearing no mask. In the case of a bag being the accessory, examples of the states of each target person and of an accessory of the target person includes the state of the target person carrying a bag over the shoulder with the hand off or placing the hand on the bag (on the fastening of the bag), and placing the hand inside the bag.

The behavior-suspiciousness determiner 33 determines the degree of suspiciousness about the behavior of each target person. Specifically, the behavior-suspiciousness determiner 33 derives or calculates a behavior score indicating the degree of suspiciousness about behaviors of the target person, from the dynamic data of the target person acquired by the data category classifier 29 and the behavior score master 16c stored in the HDD 16. The behavior score is exemplary third information.

The behavior of the target person can be determined by the motion of the target person represented by the dynamic data. That is, the behavior of the target person bases on the dynamic data, for example. The behavior-score master 16c stores therein scores individually associated with behaviors of the target person represented by the dynamic data. The behavior-suspiciousness determiner 33 acquires scores for the behavior of the target person from the behavior-score master 16c. The behavior-suspiciousness determiner 33 sets the sum of one or more acquired scores as a behavior score.

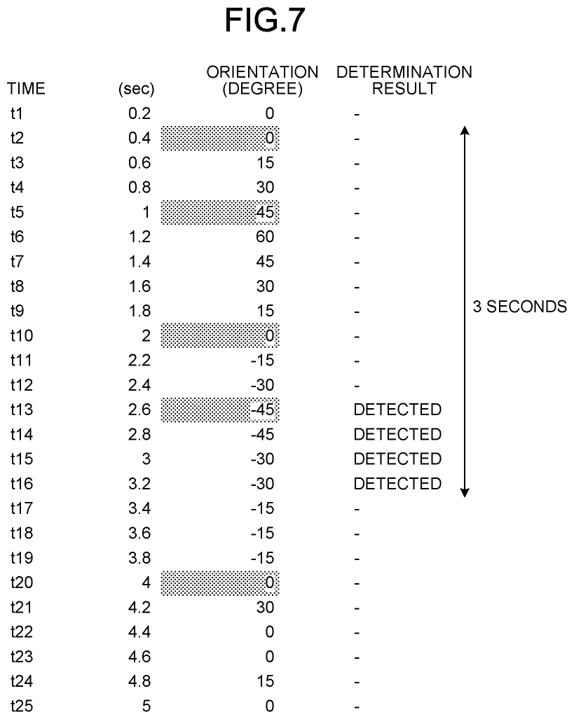

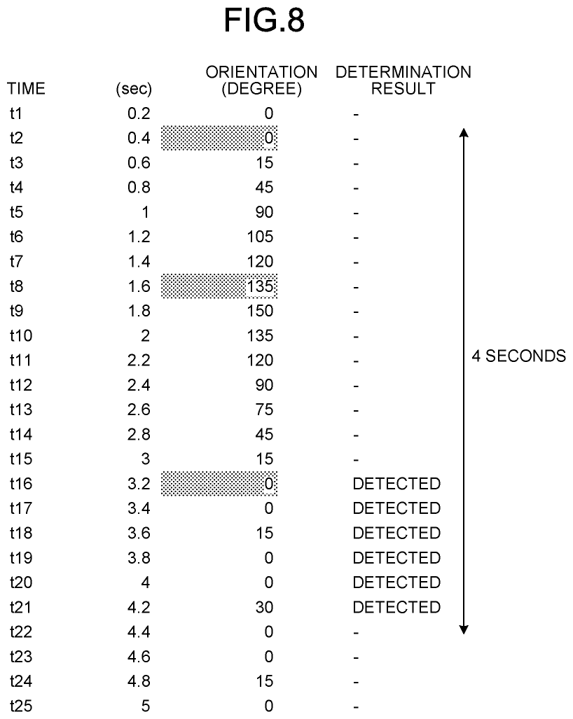

FIG. 7 illustrates an exemplary behavior suspiciousness determination process to be executed by the behavior-suspiciousness determiner 33 of the determination device 2 according to the embodiment. FIG. 8 illustrates another exemplary behavior suspiciousness determination process to be executed by the behavior-suspiciousness determiner 33 of the determination device 2 according to the embodiment. As illustrated in FIG. 7, the behavior-suspiciousness determiner 33 determines the target person as having performed a first behavior of searching the surroundings, if the target person moves his or her face in the amplitude of facial motion of 45 degrees or more twice or more in three seconds. The amplitude represents an angular change in face orientation with respect to the trunk of the body. The first behavior specifically refers to facial motion restlessly looking around. The behavior-suspiciousness determiner 33 can also detect a behavior or an action of the target person that he or she repeatedly turns his or her head to a payment location, i.e., the location of a cash register. In such a case, the behavior-suspiciousness determiner 33 acquires layout information indicating a store layout including the location for payment, that is, the cash register from a storage such as the HDD 16. As illustrated in FIG. 8, the behavior-suspiciousness determiner 33 determines that the target person has taken a second behavior of searching the surroundings, if he or she turns his or her body (trunk) by 135 degrees or more from a certain position and returns to the certain position within four seconds.

The overall suspiciousness determiner 34 determines whether the target person is a suspicious person, from a result of the determination by the appearance-suspiciousness determiner 31, a result of the determination by the state-suspiciousness determiner 32, and a result of the determination by the behavior-suspiciousness determiner 33.

As an example, the overall suspiciousness determiner 34 calculates the sum (hereinafter also referred to as total score) of the appearance score calculated by the appearance-suspiciousness determiner 31, the state score calculated by the state-suspiciousness determiner 32, and the behavior score calculated by the behavior-suspiciousness determiner 33. If the total score is greater than or equal to a threshold, the overall suspiciousness determiner 34 determines that the target person is a suspicious person. If the total score is less than the threshold, the overall suspiciousness determiner 34 determines that the target person is not a suspicious person.

As another example, the overall suspiciousness determiner 34 calculates the total score by predefined weighting on any of the appearance score, the state score, and the behavior score.

Thresholds are individually set for the appearance score, the state score, and the behavior score. As another example, if two or more of the appearance score, the state score, and the behavior score exceed their corresponding thresholds, the overall suspiciousness determiner 34 determines that the target person is a suspicious person. If two or more of the appearance score, the state score, and the behavior score do not exceed the corresponding thresholds, the overall suspiciousness determiner 34 determines that the target person is not a suspicious person.

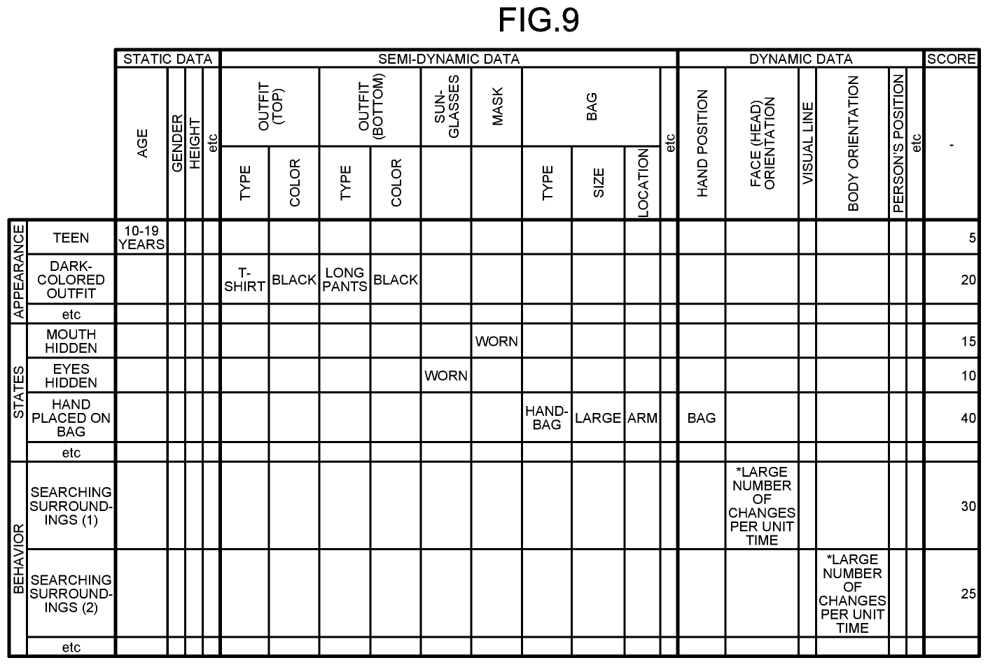

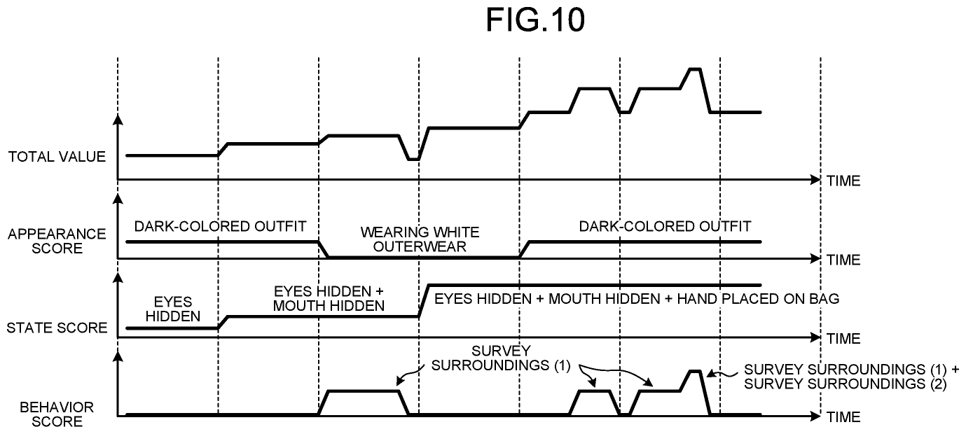

Next, examples of the above scores are described with reference to FIG. 9 and FIG. 10. FIG. 9 is a table for illustrating scores at certain time obtained through the determination by the determination device 2 according to the embodiment. The scores of each target person at certain time are sorted into one item of data in association with one another, as illustrated in FIG. 9. Thereby, the overall suspiciousness determiner 34 can calculate the total score. In the example of FIG. 9, regarding the appearance of the target person (APPEARANCE in FIG. 9) the items such as a teen and wearing a dark-colored outfit are assigned with scores. In addition, regarding the states of the target person and of accessories (STATES in FIG. 9) the items such as mouth hidden, eyes hidden, and a hand placed on a bag are assigned with scores. Regarding the behavior of the target person (BEHAVIOR in FIG. 9) the items such as the first behavior (SEARCHING SURROUNDINGS (1) in FIG. 9) and the second behavior (SEARCHING SURROUNDINGS (2) in FIG. 9) are assigned with scores.

FIG. 10 is a chart illustrating scores at certain time obtained through the determination by the determination device 2 according to the embodiment. As for the appearance of the target person, FIG. 10 illustrates an example that the target person changes in appearance, wearing dark-colored (e.g., black) clothes, wearing a white outer wear, and wearing the dark-colored clothes again. In this case, the appearance score is set to a predefined value when the target person wears dark-colored (for example, black) clothes and is set to a value (for example, zero) lower than the predefined value when the target person wears a white outer wear.

Regarding the states of the target person and of accessories of the target person, FIG. 10 illustrates an example that the target person changes in facial appearance, having the eyes hidden, having the eyes and the mouth hidden, and having the eyes and the mouth hidden and having the hand placed on a bag. The eyes are hidden by, for example, sunglasses, and the mouth is hidden by, for example, a mask. In this case, the appearance score is the lowest for having the eyes hidden, the second highest for having the eyes and the mouth hidden, and the highest for having the eyes and the mouth hidden and having the hand placed on a bag.

As for the behavior of the target person, FIG. 10 illustrates an example that the target person takes the first behavior of searching the surroundings (SEARCHING SURROUNDINGS (1) in FIG. 10) twice with an interval and then the second behavior of searching the surroundings. In this case, the behavior score is set to a predefined value while the target person performs the first behavior of searching the surroundings and is set to a higher value than the predefined value while the target person performs the second behavior of searching the surroundings.

The total value or total score of the appearance score, the state score, and the behavior score varies in accordance with changes in the individual scores.

Referring back to FIG. 3, the resultant storage 35 stores the result of determination by the determiner 30 in a storage such as the HDD 16 or a memory of the accelerator 13. The result of determination by the determiner 30 includes the appearance score, the state score, the behavior score, the total value or total score, and information on whether each target person is a suspicious person.

The resultant notifier 36 transmits or outputs the result of determination by the determiner 30 to the operation terminal 5. The resultant notifier 36 transmits, to the operation terminal 5, a screen that displays the result of determination by the determiner 30. Thus, the display device of the operation terminal 5 displays the result of determination by the determiner 30. On the screen displaying the result of determination by the determiner 30, a mark is superimposed on the target person for identifying the target person as a suspicious person. In addition, when the determiner 30 determines that the target person is a suspicious person, the resultant notifier 36 controls the loudspeaker 4 to output certain sound. The certain sound is exemplified by a message such as “What are you looking for?”. That is, when the determiner 30 determines the target person as a suspicious person, the resultant notifier 36 causes the loudspeaker 4 to talk to the target person. In this case, for example, the loudspeaker 4 located near the target person may be selected. The resultant notifier 36 is an exemplary output.

As described above, the determination device 2 of the present embodiment includes the data category classifier 29 (acquirer), the determiner 30, and the resultant notifier 36 (output). The data category classifier 29 acquires the static data (first data) representing the physical characteristics of a person, and the semi-dynamic data (second data) representing accessories of the person from image data of the person. The determiner 30 derives the appearance score (first information) from the static data and the semi-dynamic data acquired by the data category classifier 29 to determine the person. The resultant notifier 36 outputs the result of the person determination by the determiner 30. Hence, the determination device 2 of the present embodiment can determine an intended person from the perspectives of the physical characteristics of the person and accessories of the person.

In the present embodiment, the data category classifier 29 acquires the dynamic data representing motions of a person from image data, and the determiner 30 derives the state score (second information) from the semi-dynamic data by the data category classifier 29 and the dynamic data, and determines the person on the basis of the appearance score and the state score. Thus, the determination device 2 of the present embodiment can accurately determine an intended person, as compared with determining based on the appearance score alone.

In the present embodiment, the determiner 30 derives the behavior score (third information) from the behavior data acquired by the data category classifier 29, and determines a person from the appearance score, the state score, and the behavior score, for example. That is, the determination device 2 of the present embodiment can accurately determine an intended person as compared with determining based on the appearance score and the state score alone.

In the present embodiment, the data category classifier 29 acquires one or two or more items of static data and one or two or more items of semi-dynamic data, and the determiner 30 derives the appearance score from the scores individually associated with the static data and the semi-dynamic data acquired by the data category classifier 29, for example. Thus, the determination device 2 of the present embodiment can determine an intended person on the basis of scores individually associated with the static data and the semi-dynamic data.

In the present embodiment, the determiner 30 derives the state score from scores individually associated with the semi-dynamic data and the dynamic data acquired by the data category classifier 29, for example. Thus, the determination device 2 of the present embodiment can determine an intended person on the basis of the scores associated with the semi-dynamic data.

In the present embodiment, the determiner 30 derives the behavior score from the scores individually associated with the dynamic data acquired by the data category classifier 29, for example. Thus, the determination device 2 of the present embodiment can determine an intended person on the basis of the scores associated with the dynamic data.

According to one aspect, it is possible to provide a determination device and a computer program product that determine a person from a new perspective, for example.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. A determination device comprising:
an acquirer that acquires first data and second data from image data of a person, the first data representing a physical characteristic of the person, the second data representing an accessory of the person;
a determiner that derives first information from the first data and the second data, and determines the person based on the first information; and
an output that outputs a result of the determined person.

2. The determination device according to claim 1, wherein
the acquirer further acquires third data from the image data, the third data representing a motion of the person, and
the determiner derives second information from the second data and the third data, and determines the person based on the first information and the second information.

3. The determination device according to claim 2, wherein
the determiner derives third information from the third data, and determines the person based on the first information, the second information, and the third information.

4. The determination device according to claim 1, wherein
the acquirer acquires one or more items of first data representing a physical characteristic of the person, and one or more items of second data representing an accessory of the person; and
the determiner derives the first information from scores, the scores associated with the one or more items of first data and the one or more items of second data.

5. The determination device according to claim 2, wherein
the determiner derives the second information from scores, the scores associated with the second data and the third data.

6. The determination device according to claim 3, wherein
the determiner derives the third information from scores, the scores associated with the third data.

7. A computer program product including programmed instructions embodied in and stored on a non-transitory computer readable medium, wherein the instructions, when executed by a computer, cause the computer to:
acquire first data and second data from image data of a person, the first data representing a physical characteristic of the person, the second data representing an accessory of the person;
derive first information from the first data and the second data, and determining the person based on the first information; and
output a result of the determined person.
